(19) United States
(12) Patent Application Publication
(10) Pub. No.: US 2026/0152348 A1
(43) Pub. Date: Jun. 4, 2026

(54) SECURE STORAGE SYSTEM INCLUDING LOAD HANDLERS

(71) Applicant: Ocado Innovation Limited, Hatfield (GB)

(72) Inventors: Parth AMIN, Kent (GB); Mohsin SHEIKH, Chelmsford (GB); David WOOD, Cambridge (GB); Andrew FEATHERSTONE, Cambridge (GB)

(21) Appl. No.: 19/126,469

(22) PCT Filed: Nov. 2, 2023
(86) PCT No.: PCT/EP2023/080558

§ 371 Date: May 1, 2025

(30) Foreign Application Priority Data
Nov. 3, 2022 (GB) 2216377.8
Feb. 2, 2023 (GB) 2301528.2

(51) Int. Cl. B65G 1/137; B65G 1/04; B65G 1/06; H04L 9/08

(52) U.S. Cl. CPC B65G 1/1378; B65G 1/0464; B65G 1/065; H04L 9/0861; H04L 9/088

(57) ABSTRACT

The present disclosure provides a storage system in which a set of cryptographic keys are used to control the operation(s) of as load-handling device within an automated storage and retrieval system. One of the cryptographic keys may be permanently stored within the non-volatile data storage of the load-handling device and used to authenticate further keys from the set of keys to enable operations to be performed, e.g. to connect to a control system, be inducted into the storage and retrieval system, etc.

The disclosure relates to a method and system for controlling load handling devices, and in particular to such a method and system for use with robots in a storage system.

### BACKGROUND

Grid-based automatic storage and retrieval systems are well known in the art. In such systems a plurality of robotic load handlers operate on a horizontal grid structure, underneath which is received a plurality of containers, arranged in a plurality of stacks. The containers are used to hold products and the load handlers are adapted to retrieve containers from one of the plurality of stacks and to deposit a container within one of the stacks. The load handlers may be routed in an autonomous manner (or a semi-autonomous manner) on the grid but a wireless communications system is required to transmit instructions to load handlers and to enable each of the load handlers to communicate with a management system. The claimed apparatus, methods, systems and computer programs are intended to provide improvements relating to communications systems for use in an automated retrieval and storage system which uses a fleet of robotic load handlers.

### SUMMARY

According to a first aspect of the present disclosure, there is provided a method of operating a load handling device in a storage system, the method comprising the steps of: generating a set of cryptographic keys which are associated with the load handling device; storing a first cryptographic key of the set of cryptographic keys in the load handling device; using a second cryptographic key of the set of cryptographic keys to authenticate the first cryptographic key stored in the load handling device such that software can only be installed onto the load handling device if the authentication is successful.

The first cryptographic key may be permanently stored in the load handling device. The first cryptographic key may be permanently burned into a non-volatile data storage unit and the non-volatile data storage unit may be subsequently installed into the load handling device.

The method may comprise the further step of using a third cryptographic key of the set of cryptographic keys to authenticate the first cryptographic key stored in the load handling device such that the load handling device is only inducted into a storage system if the authentication is successful. Inducting the load handling device into the storage system may comprise forming a connection between the load handling device and the storage system via a wireless communication system. Alternatively, the method may comprise the further step of using a fourth cryptographic key of the set of cryptographic keys to authenticate the first cryptographic key stored in the load handling device such that the load handling device can only connect to the storage system via a wireless communication system if the authentication is successful.

The method may comprise the further step of the load handling device generating one or more local cryptographic keys for use in the load handling device. The one or more local cryptographic keys may be generated based on the first cryptographic key stored in the load handling device.

According to a second aspect of the present disclosure, there is provided a load handling device for use in a storage system, the load handling device comprising non-volatile data storage, volatile data storage, one or more processors and a first communications interface for communicating with a wireless communications network of the storage system wherein, in use, a first cryptographic key from a set of cryptographic keys associated with the load handling device is stored in the non-volatile data storage of the load handling device; and software can only installed onto the load handling device if a second cryptographic key from the set of cryptographic keys successfully authenticates the first cryptographic key.

The first cryptographic key may be permanently stored in the non-volatile data storage of the load handling device. The non-volatile data storage of the load handling device may comprise a one-time programmable memory device.

The load handling device may further comprise a cryptoprocessor. The cryptoprocessor may be configured to generate one or more further cryptographic keys. The cryptoprocessor may be configured to generate one or more further cryptographic keys based on the first cryptographic key stored in the non-volatile data storage of the load-handling device.

The load handling device may only be inducted into a storage system if a third cryptographic key from the set of cryptographic keys successfully authenticates the first cryptographic key. Inducting the load handling device into the storage system may comprise forming a connection between the load handling device and the storage system via a wireless communication system. Alternatively, the load handling device may only connect to the storage system via the first communications interface if a fourth cryptographic key from the set of cryptographic keys successfully authenticates the first cryptographic key.

According to a third aspect there is provided a storage system comprising: a first set of parallel tracks extending in an X-direction, and a second set of parallel tracks extending in a Y-direction transverse to the first set in a substantially horizontal plane to form a grid pattern comprising a plurality of grid spaces; a plurality of stacks of storage containers located beneath the tracks, and arranged such that each stack is located within a footprint of a single grid space; at least one transporting device as described above, the at least one transporting device being arranged to selectively move in the X and/or Y directions, above the stacks on the tracks and arranged to transport a storage container; and a picking station arranged to receive a storage container transported by the at least one transporting device and to transfer an item from the storage container into a delivery container. The at least one transporting device may have a footprint that occupies only a single grid space in the storage system, such that a transporting device occupying one grid space does not obstruct a transporting device occupying or traversing the adjacent grid spaces in the X and/or Y directions.

According to a further aspect there is provided a data carrier device comprising computer executable code for performing a method according as described above.

### BRIEF DESCRIPTION OF THE DRAWINGS

The communication system will now be described in detail with reference to examples, in which:

FIG. 1 schematically illustrates a storage structure and containers;

FIG. 2 schematically illustrates track on top of the storage structure illustrated in FIG. 1;

FIG. 3 schematically illustrates load handling devices on top of the storage structure illustrated in FIG. 1;

FIG. 4 schematically illustrates a single load handling device with container-lifting means in a lowered configuration;

FIG. 5 schematically illustrates cutaway views of a single load handling device with container-lifting means in a raised and a lowered configuration;

FIG. 6 shows a schematic depiction of a communications system which enables a plurality of bots to communicate with a central computing device;

FIG. 7 shows a schematic depiction of a system which enables the deployment of software to a bot in an automated storage and retrieval system;

FIG. 8 shows a schematic depiction of a further example of the communications system of FIGS. 6 and 7;

FIG. 9 shows a schematic depiction of a bot PC;

FIG. 10 shows a schematic depiction of a method by which the cryptographic keys can be transferred;

FIG. 11 shows a schematic depiction of an example of the bootloader code; and

FIG. 12 shows a schematic depiction of a computer device 1000 used in the implementation of a communications system.

### DETAILED DESCRIPTION

The following embodiments represent the applicant's preferred examples of how to implement a communications system for use with robots in a warehouse but they are not necessarily the only examples of how that could be achieved.

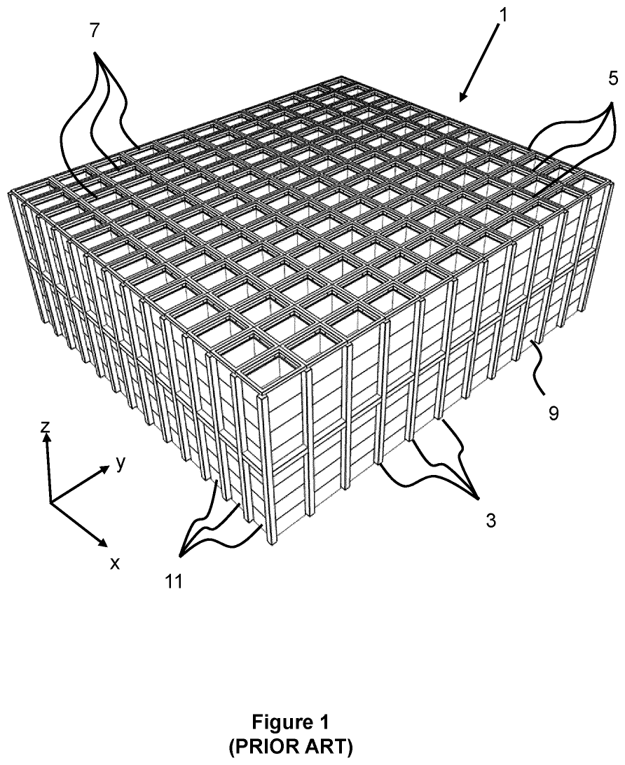

FIG. 1 illustrates a storage structure 1 comprising upright members 3 and horizontal members 5, 7 which are supported by the upright members 3. The horizontal members 5 extend parallel to one another and the illustrated x-axis. The horizontal members 7 extend parallel to one another and the illustrated y-axis, and transversely to the horizontal members 5. The upright members 3 extend parallel to one another and the illustrated z-axis, and transversely to the horizontal members 5, 7. The horizontal members 5, 7 form a grid pattern defining a plurality of grid cells. In the illustrated example, containers 9 are arranged in stacks 11 beneath the grid cells defined by the grid pattern, one stack 11 of containers 9 per grid cell.

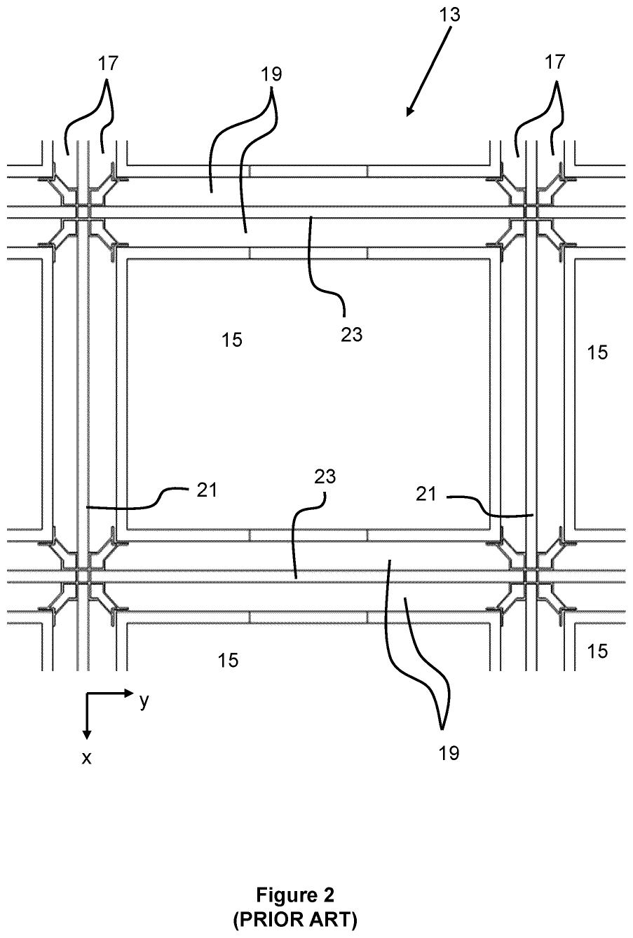

FIG. 2 shows a large-scale plan view of a section of track structure 13 forming part of the storage structure 1 illustrated in FIG. 1 and located on top of the horizontal members 5, 7 of the storage structure 1 illustrated in FIG. 1. The track structure 13 may be provided by the horizontal members 5, 7 themselves (e.g. formed in or on the surfaces of the horizontal members 5, 7) or by one or more additional components mounted on top of the horizontal members 5, 7. The illustrated track structure 13 comprises x-direction tracks 17 and y-direction tracks 19, i.e. a first set of tracks 17 which extend in the x-direction and a second set of tracks 19 which extend in the y-direction, transverse to the tracks 17 in the first set of tracks 17. The tracks 17, 19 define apertures 15 at the centres of the grid cells. The apertures 15 are sized to allow containers 9 located beneath the grid cells to be lifted and lowered through the apertures 15. The x-direction tracks 17 are provided in pairs separated by channels 21, and the y-direction tracks 19 are provided in pairs separated by channels 23. Other arrangements of track structure may also be possible.

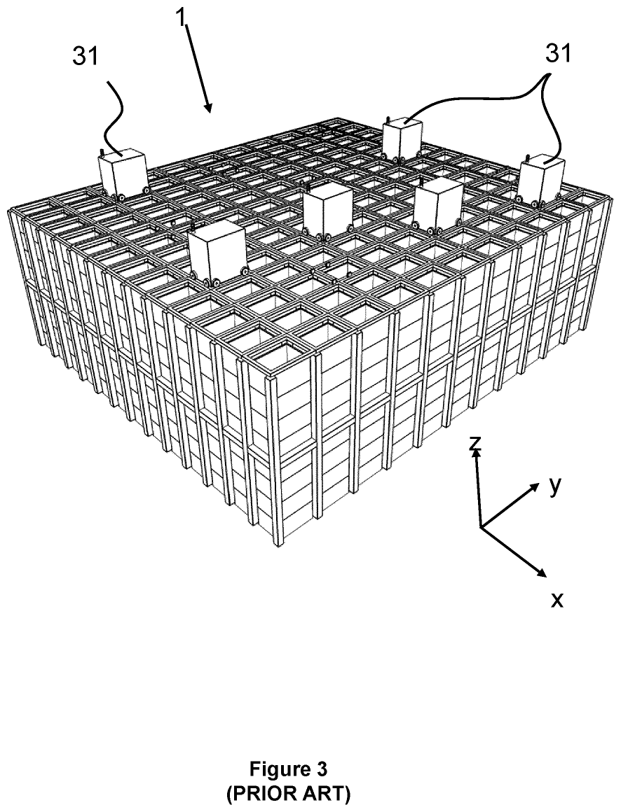

FIG. 3 shows a plurality of load handling devices 31 moving on top of the storage structure 1 illustrated in FIG. 1. The load handling devices 31, which may also be referred to as robots 31 or bots 31, are provided with sets of wheels to engage with corresponding x- or y-direction tracks 17, 19 to enable the bots 31 to travel across the track structure 13 and reach specific grid cells. The illustrated pairs of tracks 17, 19 separated by channels 21, 23 allow bots 31 to occupy (or pass one another on) neighbouring grid cells without colliding with one another.

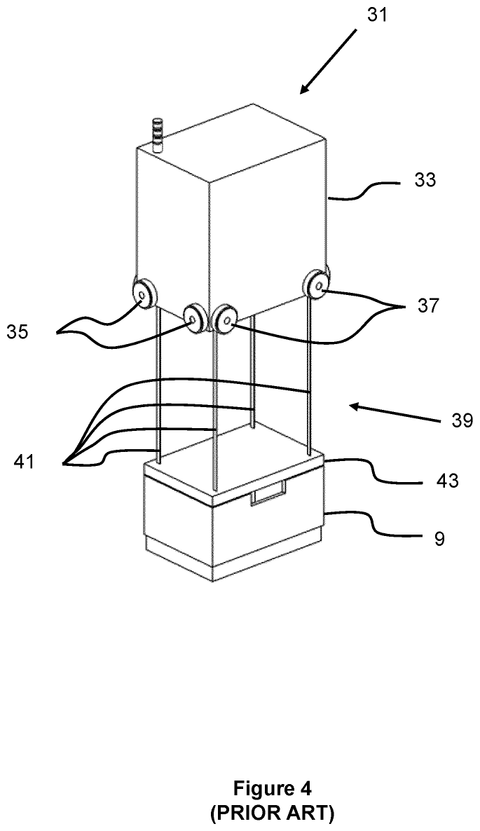

As illustrated in detail in FIG. 4, a bot 31 comprises a body 33 in or on which are mounted one or more components which enable the bot 31 to perform its intended functions. These functions may include moving across the storage structure 1 on the track structure 13 and raising or lowering containers 9 (e.g. from or to stacks 11) so that the bot 31 can retrieve or deposit containers 9 in specific locations defined by the grid pattern.

The illustrated bot 31 comprises first and second sets of wheels 35, 37 which are mounted on the body 33 of the bot 31 and enable the bot 31 to move in the x- and y-directions along the tracks 17 and 19, respectively. In particular, two wheels 35 are provided on the shorter side of the bot 31 visible in FIG. 4, and a further two wheels 35 are provided on the opposite shorter side of the bot 31 (side and further two wheels 35 not visible in FIG. 4). The wheels 35 engage with tracks 17 and are rotatably mounted on the body 33 of the bot 31 to allow the bot 31 to move along the tracks 17. Analogously, two wheels 37 are provided on the longer side of the bot 31 visible in FIG. 4, and a further two wheels 37 are provided on the opposite longer side of the bot 31 (side and further two wheels 37 not visible in FIG. 4). The wheels 37 engage with tracks 19 and are rotatably mounted on the body 33 of the bot 31 to allow the bot 31 to move along the tracks 19.

The bot 31 also comprises container-lifting means 39 configured to raise and lower containers 9. The illustrated container-lifting means 39 comprises four tapes or reels 41 which are connected at their lower ends to a container-engaging assembly 43. The container-engaging assembly 43 comprises engaging means (which may, for example, be provided at the corners of the assembly 43, in the vicinity of the tapes 41) configured to engage with features of the containers 9. For instance, the containers 9 may be provided with one or more apertures in their upper sides with which the engaging means can engage. Alternatively or additionally, the engaging means may be configured to hook under the rims or lips of the containers 9, and/or to clamp or grasp the containers 9. The tapes 41 may be wound up or down to raise or lower the container-engaging assembly, as required. One or more motors or other means may be provided to effect or control the winding up or down of the tapes 41.

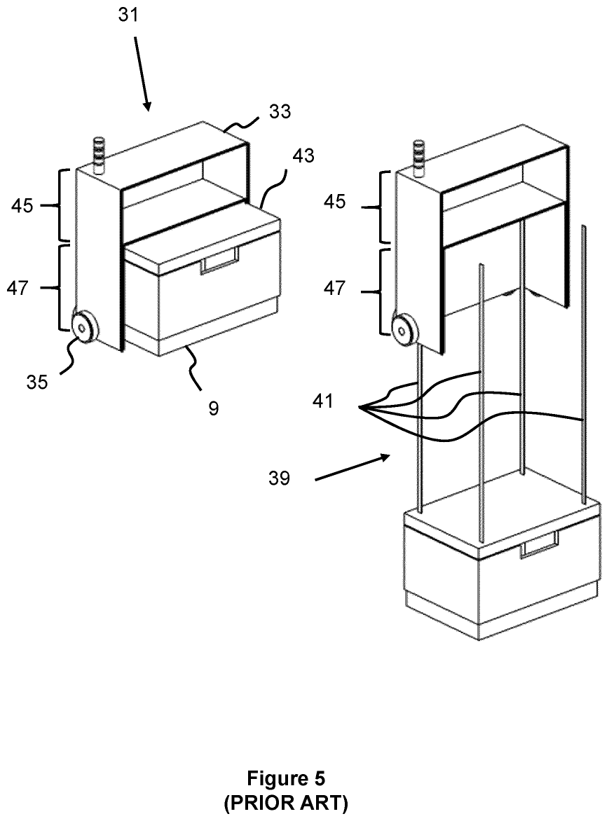

As can be seen in FIG. 5, the body 33 of the illustrated bot 31 has an upper portion 45 and a lower portion 47. The upper portion 45 is configured to house one or more operation components (not shown). The lower portion 47 is arranged beneath the upper portion 45. The lower portion 47 comprises a container-receiving space or cavity for accommodating at least part of a container 9 that has been raised by the container-lifting means 39. The container-receiving space is sized such that enough of a container 9 can fit inside the cavity to enable the bot 31 to move across the track structure 13 on top of storage structure 1 without the underside of the container 9 catching on the track structure 13 or another part of the storage structure 1. When the bot 31 has reached its intended destination, the container-lifting means 39 controls the tapes 41 to lower the container-gripping assembly 43 and the corresponding container 9 out of the cavity in the lower portion 47 and into the intended position. The intended position may be a stack 11 of containers 9 or an egress point of the storage structure 1 (or an ingress point of the storage structure 1 if the bot 31 has moved to collect a container 9 for storage in the storage structure 1). Although in the illustrated example the upper and lower portions 45, 47 are separated by a physical divider, the upper and lower portions 45, 47 may not be physically divided by a specific component or part of the body 33 of the bot 31.

To enable the bot 31 to move on the different wheels 35, 37 in the first and second directions, the bot 31 includes a wheel-positioning mechanism for selectively engaging either the first set of wheels 35 with the first set of tracks 17 or the second set of wheels 37 with the second set of tracks 19. The wheel-positioning mechanism is configured to raise and lower the first set of wheels 35 and/or the second set of wheels 37 relative to the body 33, thereby enabling the load handling device 31 to selectively move in either the first direction or the second direction across the tracks 17, 19 of the storage structure 1.

The wheel-positioning mechanism may include one or more linear actuators, rotary components or other means for raising and lowering at least one set of wheels 35, 37 relative to the body 33 of the bot 31 to bring the at least one set of wheels 35, 37 out of and into contact with the tracks 17, 19. In some examples, only one set of wheels is configured to be raised and lowered, and the act of lowering the one set of wheels may effectively lift the other set of wheels clear of the corresponding tracks while the act of raising the one set of wheels may effectively lower the other set of wheels into contact with the corresponding tracks. In other examples, both sets of wheels may be raised and lowered, advantageously meaning that the body 33 of the bot 31 stays substantially at the same height and therefore the weight of the body 33 and the components mounted thereon does not need to be lifted and lowered by the wheel-positioning mechanism.

To remove a container 9 from the top of a stack 11, the bot 31 is moved as necessary in the X and Y directions so that the container-gripping assembly 43 is positioned above the stack 11. The container-gripping assembly 43 is then lowered vertically in the Z direction to engage with the container 9 on the top of the stack 11. The container-gripping assembly 43 grips the container 9, and is then pulled upwards on the tapes 41, with the container 9 attached. At the top of its vertical travel, the container 9 is accommodated within the vehicle body and is held above the level of the tracks. In this way, the load handling device 30 can be moved to a different position in the X-Y plane, carrying the container 9 along with it, to transport the container 9 to another location. The tapes 41 are long enough to allow the load handling device 30 to retrieve and place containers from any level of a stack 11, including the floor level. The weight of the vehicle may be comprised in part of batteries that are used to power the drive mechanism for the wheels 35, 37.

As shown in FIG. 3, a plurality of load handling devices 31 are provided, so that each bot 31 can operate simultaneously to increase the throughput of the system. The system illustrated in FIG. 3 may include specific locations, known as ports, at which containers 9 can be transferred into or out of the system. An additional conveyor system (not shown) is associated with each port, so that containers 9 transported to a port by a bot 31 can be transferred to another location by the conveyor system, for example to a picking station (not shown). Similarly, containers 9 can be moved by the conveyor system to a port from an external location, for example to a container-filling station (not shown), and transported to a stack 11 by the bots 31 to replenish the stock in the system.

Each bot 31 can lift and move one container 9 at a time. If it is necessary to retrieve a container (“target container”) that is not located on the top of a stack 11, then the overlying containers (“non-target containers”) must first be moved to allow access to the target container. This is achieved in an operation referred to hereafter as “digging”. During a digging operation, one of the bots 31 sequentially lifts each non-target container 9a from the stack 11 containing the target container 9b and places it in a vacant position within another stack 11. The target container 9b can then be accessed by the bot 31 and moved to a port for further transportation.

Each of the bots 31 is under the control of a grid controller. Each individual container 9 in the system is tracked, so that the appropriate containers 9 can be retrieved, transported and replaced as necessary. For example, during a digging operation, the locations of each of the non-target containers is logged, so that the non-target containers can be tracked.

The system described with reference to FIGS. 1 to 5 has many advantages and is suitable for a wide range of storage and retrieval operations. In particular, it allows very dense storage of product, and it provides a very economical way of storing a huge range of different items in the containers 9, while allowing reasonably economical access to all of the containers 9 when required for picking.

It should be understood that it is necessary for messages to be transmitted to the bots. These may be short messages, for example an instruction to move a container from a first location to a second location, or the messages may be larger, for example an update to the computer code which is used to operate the bot or a component of the bot. Similarly, it may be necessary for the bot to send messages to a central management system, for example to report operating parameter values, operating state reports etc. An example of a communications system which can be used is disclosed in the Applicant's international patent application WO 2015/185726.

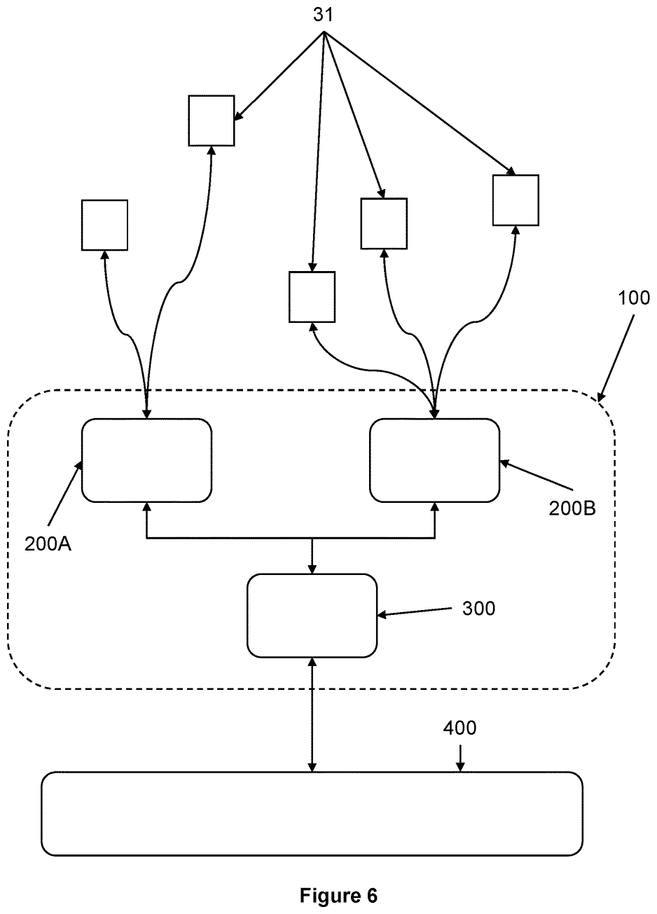

FIG. 6 shows a schematic depiction of a communications system 100 which enables a plurality of bots 31 to communicate with a central computing device 400. The central computing device executes a number of different computer programs such that it is able to transmit instructions to each of the plurality of bots and to receive messages back from each of the plurality of bots. The messages sent from the central computing device to a bot may instruct the bot to: move to a specific grid location; deposit the container it is carrying at its present location; retrieve the top-most container from its current location; move to a charging point for battery charging; etc. The messages returned by a bot to the central computing device may comprise: an acknowledgement that a message from the computing device has been received and is being actioned; a request that the bot moves to a charging point for battery charging; a request that the bot returns for maintenance activity etc. The central computing device controls the operation of the storage and retrieval system such that, amongst other things. products received are stored for subsequent retrieval; stored products are retrieved such that customer orders can be picked, packed and despatched in a timely manner; the products stored within the storage and retrieval system are arranged & re-arranged to support the efficient operation of the system.

The communications system 100 comprises base stations 200A and 200B. Each of the bots 31 comprises a radio antenna such that it can communicate with one of the base stations. The communications system may further comprise a base station controller (BSC) 300 which controls the operation of the base stations, for example when a bot is being handed over from a first base station to a second base station. The BSC is in communication with the computing device and is configured to route messages from the computing device to a bot via the appropriate base station, and vice versa. Known wireless communications systems for use with such automated storage and retrieval systems are disclosed in WO 2015/185726, WO 2018/127437 and WO 2018/177788. In an alternative, for example if the communications system is designed to cover a large warehouse or fulfilment centre, the communications system may comprise more than two base stations. In a yet further alternative, for example if the communications system is designed to cover a smaller warehouse or fulfilment centre, then the communications may only comprise a single base station. In such a case, the base station controller is not required in the communications system.

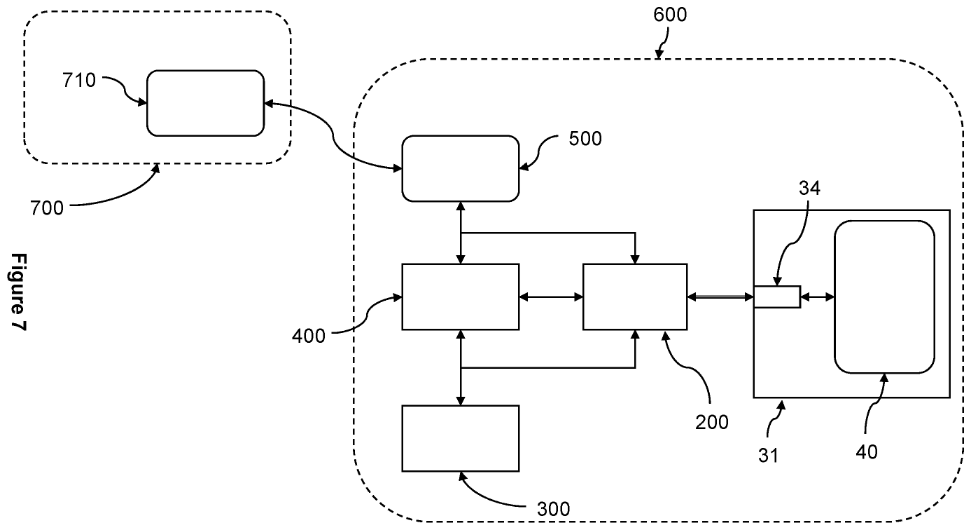

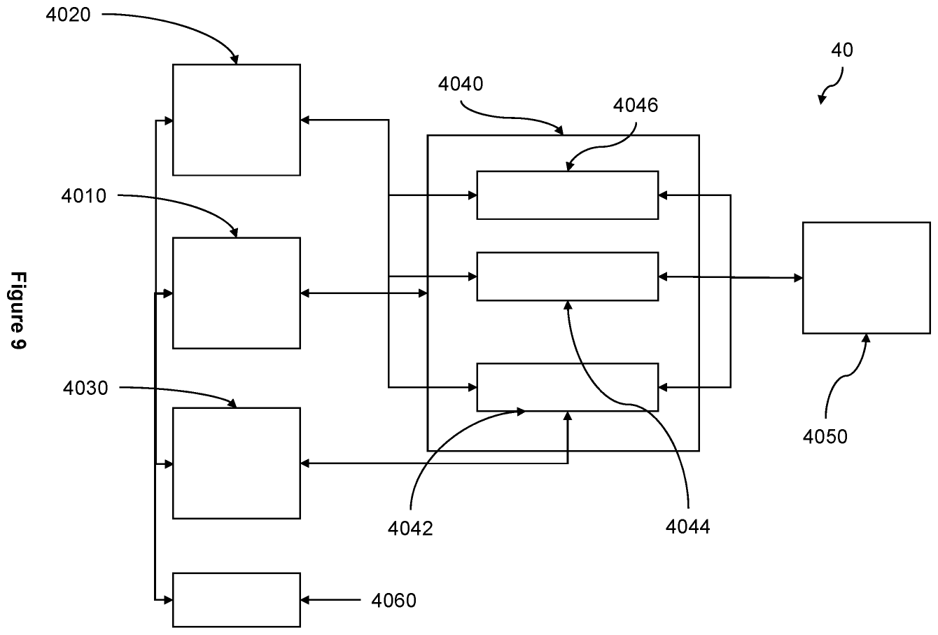

FIG. 7 shows a schematic depiction of a system which enables the secure deployment of software code to a bot 31 which is operating as a part of an automated storage and retrieval system. The system comprises one or more base stations 200 (only one of which is shown in FIG. 7 for the sake of clarity), a base station controller (BSC) 300, central computing device 400, a cryptographic server 500 and a plurality of bots 31 (again, for the sake of clarity only one of the plurality of bots is shown in FIG. 7). Further to the preceding discussion in relation to FIGS. 3 to 5, each of the plurality of bots 31 further comprises a communications interface 34 and a bot PC 40. The communications interface 34 enables communication between the bot and a base station 200 and may comprise a suitable modem device, for example a 4G modem, WiFi modem, etc. The communications interface 34 is connected to the bot PC 40 such that signals received from a base station can be routed to the bot PC and vice versa. The structure of the bot PC 40 will be described below with reference to FIG. 9.

Thus, it can be seen that messages can be communicated between the central computing device and the bot PC of a bot, such that control messages transmitted by the central computing device can be received by a bot PC and the message then processed such that the bot takes action: for example, the bot may; activate one of the drive mechanisms of the bot to move the bot in its present direction; activate the container-lifting means to lower or lift a container; activate the wheel-positioning mechanism so as to change the direction in which the bot will move, etc. Similarly, messages from the bot PC may be routed back to the central computing device such that, for example, if data generated in a bot, for example from a sensor, is indicative of an imminent failure state then the central computing device can instruct the bot to return to a maintenance area such that preventative action can be taken or alternatively, the bot may be remotely directed back to a maintenance area.

Each fulfilment centre will comprise such a communication system and it should be understood that a single enterprise is likely to comprise a plurality of such fulfilment centres. The components which form each of these systems can be considered to form a separate security zone 600. Each of those security zones may be connected to an enterprise security zone 700. The enterprise security zone 700 may comprise an enterprise cryptographic server 710.

In use, cryptographic operations may be used in the operation of a bot PC, and by extension the operation of a bot. For each of the bots to be operated within a fulfilment centre a set of cryptographic keys are generated, such that each set of cryptographic keys comprises one or more cryptographic keys. For example, the enterprise cryptographic server 710 may be used to generate a set of cryptographic keys for each of the plurality of bots that operate in each of the fulfilment centres that are operated by the enterprise which operates the enterprise cryptographic server 710. The set of keys may be then be transferred to the respective bots and then used in the operation of the bots. The keys may be distributed to the respective bots via the cryptographic server 500 for the fulfilment centre in which the bot operates. Alternatively, a cryptographic server 500 may generate the plurality of sets of keys that are required for use by the plurality of bots which are active in that fulfilment centre. The creation of the sets of keys by the cryptographic server may be initiated or otherwise controlled by the enterprise cryptographic server.

The enterprise cryptographic server and the or each cryptographic server 500 perform the functions of a certificate authority within a public key infrastructure, and that of other entities, such that digital certificates and cryptographic keys can be created, managed and revoked as required to facilitate the operation of the bots within a fulfilment centre, and other operations of the fulfilment centre, in a secure manner.

In some cases, it may be possible for a fulfilment centre to not have a cryptographic server deployed within in it. In such case, the necessary cryptographic functionality may be provided by the enterprise cryptographic server. In an alternative arrangement, a cryptographic server located on one fulfilment centre may provide the required cryptographic functionality for one or more further fulfilment centres. In a further variant, the enterprise cryptographic server may provide the required cryptographic functionality for all of the fulfilment centres.

It will be seen from the following discussion that one or more of the set of cryptographic keys may need to be supplied to a different entity. For example, a company which operates automated storage and retrieval systems to deliver products to customers is unlikely to be manufacturing the bots which are operated within the storage and retrieval system. In such a case, it will be necessary to transfer a key (or keys) for each bot which is to be manufactured. The manufacturer will need to operate a further cryptographic server which is capable of receiving and managing the received keys. Secure communications channels will need to be provided to ensure the secure transmission of keys between different entities.

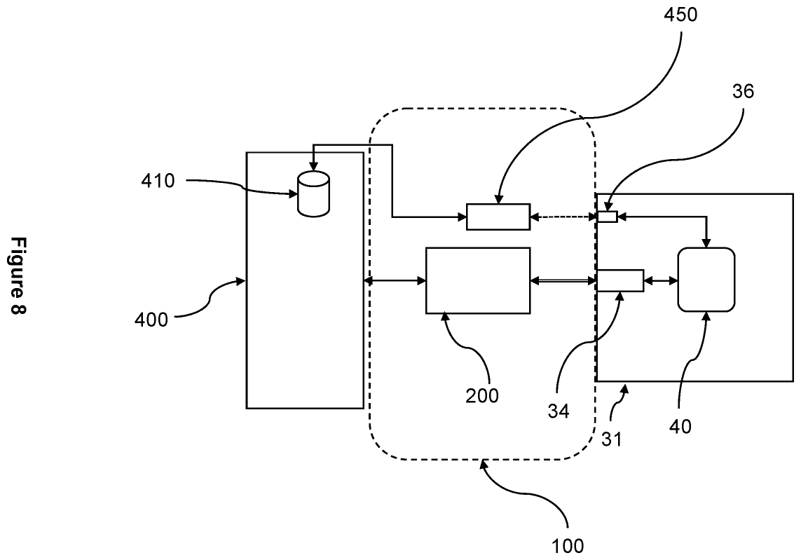

FIG. 8 shows a schematic depiction of a further example of the communications system 100 described above with reference to FIGS. 6 and 7. In this example, the communications system 100 further comprises a second wireless communications network. In one example the second wireless communications network is a point-to-point wireless communications network and comprises one or more point-to-point wireless transceivers. The or each transceiver 450 of the second wireless communications network is connected to the central computing device 400, for example by fixed Ethernet communication links. More specifically, the second wireless communications network is a point-to-point optical free space communications network. It should be understood that while the cryptographic server 500 and the base station(s) 300 are not shown in FIG. 8 for the sake of clarity, they are still present in the communications system of FIG. 8.

Each of the plurality of bots may further comprise a second network interface 36, which is connected to the bot PC 40. The second network interface is also configured such that the bot PC is able to communicate with the central computing device via the second wireless communications network. The central computing device may comprise a software repository 410 which comprises the operating system and one or more applications necessary to control the operation of the bot (see below in relation to FIG. 9). If the software of a bot requires an update then the necessary files may be transferred from the software repository to the bot via the second wireless communications network and then installed onto the bot PC.

It should be understood that the software repository may, in an alternative, be stored elsewhere, for example on a server or cloud computing platform which is communicably connected to the central computing device and from which software can be transferred to a bot.

The second wireless communications network may comprise a plurality of transceivers which are configured such that they can communicate with a bot which is located at a predetermined grid cell location. In one example, if a bot requires an upgrade to one or more of the elements of the software that operates the bot PC then the bot can navigate to one of the predetermined grid cell locations such that the second network interface 36 of the bot can communicate with one of the plurality of transceivers of the second wireless communications network. In a further example, the transceivers of the second wireless communications network may be configured such that they can communicate with a bot which is located a charging location, which may be located at the perimeter of the grid. Thus, when a bot moves to a charging location, to recharge the battery (or batteries) that power the bot, then the bot can connect to the central computing device via the second wireless communications network. If one or more of the elements of the software that operates the bot PC require an upgrade than those elements can be transferred from the software repository to the bot via the second wireless communications network and then installed onto the bot PC.

FIG. 9 shows a schematic depiction of a bot PC 40 which comprises central processing unit (CPU) 4010, random access memory (RAM) 4020, read only memory (ROM) 4030, non-volatile data storage unit 4040, cryptoprocessor 4050 and one-time programmable memory (OTPM) 4060. The non-volatile data storage unit 4040 comprises a bootloader 4042, an operating system 4044 and one or more applications 4046. The bot PC is configured such that the CPU is communicably connected to each of the RAM, the ROM, the non-volatile data storage unit and the OTPM such that the CPU may: access data stored within one or more of those entities; process the accessed data; or write data to the RAM and/or the non-volatile data storage unit. It will be appreciated in the light of the above that the CPU is also communicatively coupled to the communications interface 34 such that data received from the communications system 100 may be transferred to the CPU for processing and, similarly, data generated by the CPU may be routed to the central computing device 400 via the communications interface 34 and the communications system. The bot PC is further configured such that the each of the bootloader 4042, the operating system 4044 and the one or more applications 4046 can communicate with the cryptoprocessor 4050. In one example, the operating system and the one or more applications may be integrated into a single software package which can control the operation of the bot, communicate with the communications system, etc. In a further example, the operating system may comprise a variant of Linux and the one or more applications may comprise a single computer program. The operating system and the one or more applications may comprise firmware.

In use, cryptographic operations may be used in the operation of a bot PC, and by extension the operation of a bot. For each of the bots to be operated within a fulfilment centre a set of cryptographic keys are generated, such that each set of cryptographic keys comprises one or more cryptographic keys. As discussed above, each set of cryptographic keys may be generated by the enterprise cryptographic server or by a cryptographic server 500.

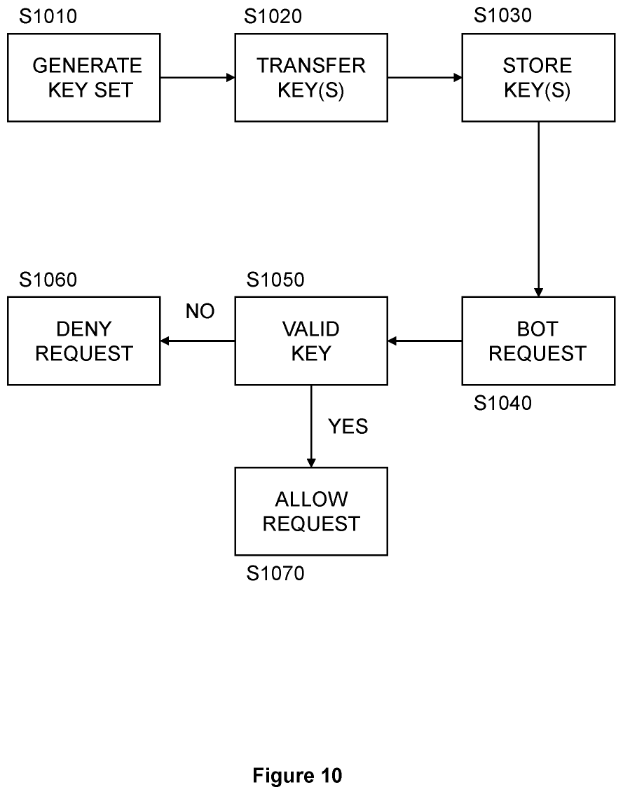

FIG. 10 shows a schematic depiction of a method by which the cryptographic keys can be transferred. At S1010 a key set is generated for one of the plurality of bots. One or more of the keys of the key set is then transferred to the respective bot (S1020). such that the received keys are then stored by the bot (S1030). Subsequently the bot may make a request (S1040), for example, to connect to the communications system 100 via one of the base stations 200. It will be understood from the following discussion that the bot may make requests of different types. One of the keys held by the bot may be presented and if a cryptographic challenge is passed then the bot request is allowed (S1070). For example, a private cryptographic key held in a cryptography server may be used to decode a request which has been encoded by a public cryptographic key held by the bot. If the cryptographic challenge is not passed then the bot request is denied (S1060).

In one example, in step S1020 one or more private keys and/or one or more public keys are transferred to the bot, such that one or more further private keys are retained at the cryptographic server. One or more public keys may also be retained at the cryptographic server. The key(s) received by the bot may be stored in the non-volatile data storage unit of the bot PC. In one example, a key may be permanently written into the one-time programmable memory (OTPM) 4060 such that the key is permanently associated with the respective bot. Thus, it is necessary that that key is to be updated or replaced with a new key then it will be necessary to remove the OTPM from the bot PC, replacing it with a new OTPM module and then permanently writing a new key into the new OTPM. The permanently stored key may be a public key or a private key. One or more keys may be permanently stored in the OTPM.

A public key stored in the bot may be used to encrypt a message that can be sent to the cryptographic server. The cryptographic server may then decrypt the message using one of the private keys held in the cryptographic server, the private key being selected from the same set of cryptographic keys as the public key stored in the bot. A response to the message to the bot can then be sent. For example, the bot may request to connect to a base station 200 of the communications network 100. If the correct key is used to encrypt the request then the bot is allowed to connect to the communications network. In the case where one or more keys are transmitted to a bot by the cryptographic server and a key is permanently written into the OTPM then it can be seen that access to the communications network can be controlled, to a level that is more secure than relying on credentials such as a bot ID and a password.

The bot PC comprises a cryptoprocessor, which may be, for example, a Trusted Platform Module (TPM). The cryptoprocessor may generate one or more further keys which can then be used by the bot, either for operations which are internal to the bot or for operations which involve entities external to the bot. These one or more further keys may be generated based on one or more of the key(s) received from the cryptographic server. For example, the cryptoprocessor may be used to generate a symmetric key which can be used to encrypt the contents of the non-volatile data storage unit. Alternatively, one or more symmetric keys may be generated and used to encrypt the contents of one or more of the bootloader, the operating system and the one or more applications. Alternatively, or in addition, an asymmetric key may be generated which is then used to create a device identity which can be used by the bot in communications with the central communications device 400.

As discussed above, the software for a bot can be accessed by the bot from the software repository 410, which may be stored within the central computing device. To control the software that is deployed to bots, the software packages can be signed using a cryptographic key generated by a cryptographic server. Furthermore, a key held by a bot can be used to authenticate the or each software package that the bot needs to download. Alternatively, or in addition, a bot may only be able to access the software repository if it can present an appropriate key to the central computing device.

Table 1 below gives en example of a set of keys that could be stored and used by a bot

TABLE 1
Exemplary set of keys held by a bot

| Key | | Key | Generated | |
|---|---|---|---|---|
| Number | Purpose | Type | by | Strength |
| 1 | Signing and | Asymmetric - | Cryptographic | 4 × |
| | verifying | related to | server | SHA-384 |
| | hardware | OTPM | | |
| 2 | Signing and | Asymmetric | Cryptographic | SHA-256 |
| | verifying | | server | RSA-2048 |
| | operating | | | |
| | system | | | |
| 3 | Device | Asymmetric | Created by | SHA-256 |
| | Identity - | | TPM, which | RSA-2048 |
| | for TLS/DTLC | | requests a | |
| | communication | | certificate from | |
| | | | cryptographic | |
| | | | server | |
| 4 | Disc | Symmetric | Created by | AES-128 |
| | Encryption | | TPM, no | AES-256 |
| | | | interaction | |
| | | | with | |
| | | | cryptographic | |
| | | | server | |
| 5 | Radio | Symmetric | Cryptographic | AES-128 |
| | Encryption | | server | |
| 6 | RAUC - image | Asymmetric | Cryptographic | SHA-256 |
| | signing | | server | RSA-2048 |
| | certificate | | | |
| | for operating | | | |
| | system updates | | | |
| 7 | CA certificates | Asymmetric | Cryptographic | ECDH & |
| | | | server | SHA-256 & |
| | | | | RSA-2048 |
| 8 | Certificate | Asymmetric | Cryptographic | ECDH & |
| | based SSH | | server | SHA-256 & |
| | | | | RSA-2048 |

It can be seen from Table 1 that the use of such an exemplary set of keys would make use of cryptographic keys to ensure that: only an authorised bot could connect to the communications network; that only firmware that had been cryptographically signed could be downloaded and installed onto the bot; that the wireless communications between a bot and the central computing device are encrypted; that the data stored in the bot is encrypted; and that the central computing device can initiate a secure remote log-in to the bot, for example for maintenance purposes.

It will be understood that in some deployments of bots not all of the these keys will be used as some may not be needed. For example, a security audit may determine that if a security risk is below a predetermined level then there is no need to take mitigations against it. Alternatively, it may be necessary to use further keys to protect other aspects of the bots operation. For example, it may be necessary to provide two separate device identity keys. One of keys can be used to enrol the bot with the network and the second may be used for ongoing communication with a base station of the communications network. It will be understood that keys of greater strengths may be used if it is deemed necessary.

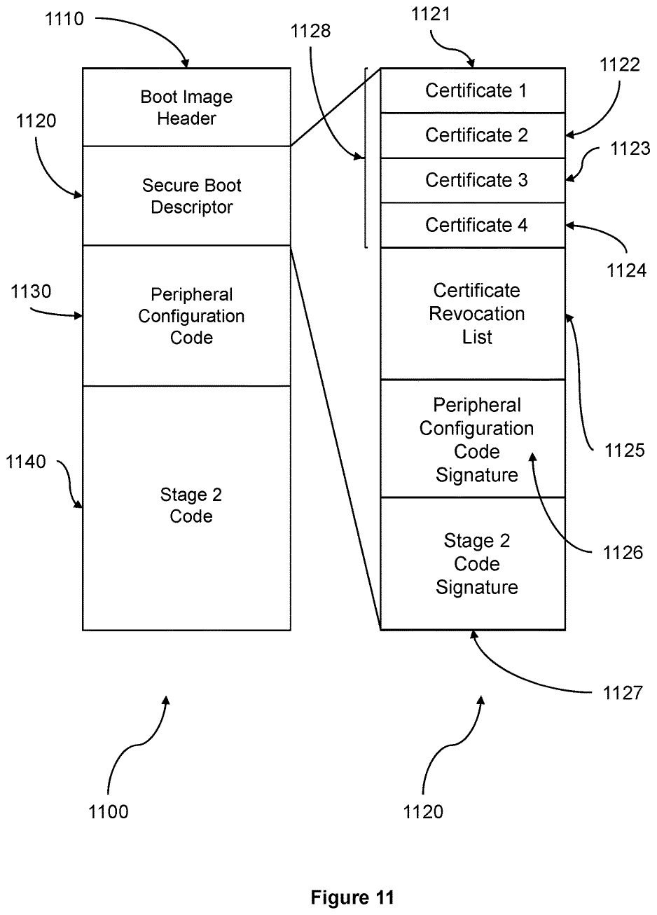

FIG. 11 shows a schematic depiction of an example of the contents of the code which is written into the bootloader 4042 of a bot (see FIG. 9). The boot image 1100 comprises a boot image header 1110, secure boot descriptor 1120, peripheral configuration code 1130 and stage 2 code 1140. The secure boot 1120 descriptor comprises certificate 1 1121, certificate 2 1122, certificate 3 1123, certificate 4 1124, certificate revocation list (CRL) 1125, peripheral configuration code signature 1126 and Stage 2 code signature 1127.

The boot up header 1110 defines the locations of the different elements of the boot image 1100 in the boot loader. On boot up, the secure boot descriptor 1120 is loaded into memory. The four certificates (certificate 1, certificate 2, certificate 3 & certificate 4) are referred to as a certificate block 1128. A hash of the certificate block can be permanently written into the OTPM. Thus, on boot up, the contents of the certificate block can be hashed and compared with the value stored in the OTPM. If the values do not match then the boot up is aborted as the certificate values have been changed. If there is a match then the boot up process can proceed.

The peripheral code signature code can be compared with the peripheral code stored in the bootloader. Again, if there is a match then the boot up procedure can proceed but if there is no match then the boot up is aborted. The next step is to compare the Stage 2 code signature with the Stage 2 code, with the boot up proceeding if there is a match between the signature and the code. The execution of the Stage 2 code causes the operating system and then the one or more applications to be executed. If there is no match then the boot up process is aborted. The failure of a bot to boot up is likely to be due to a file being corrupted or an incorrect key being used to generate a certificate or a signature. Such errors must be remedied such that the bot can be used subsequently

The CRL holds a list of certificates which have been revoked, for example, by the enterprise cryptographic server and which are no longer recognised. The four certificates (certificate 1, certificate 2, certificate 3 & certificate 4) are, in one example, derived from keys 1 to 4 listed above in table 1.

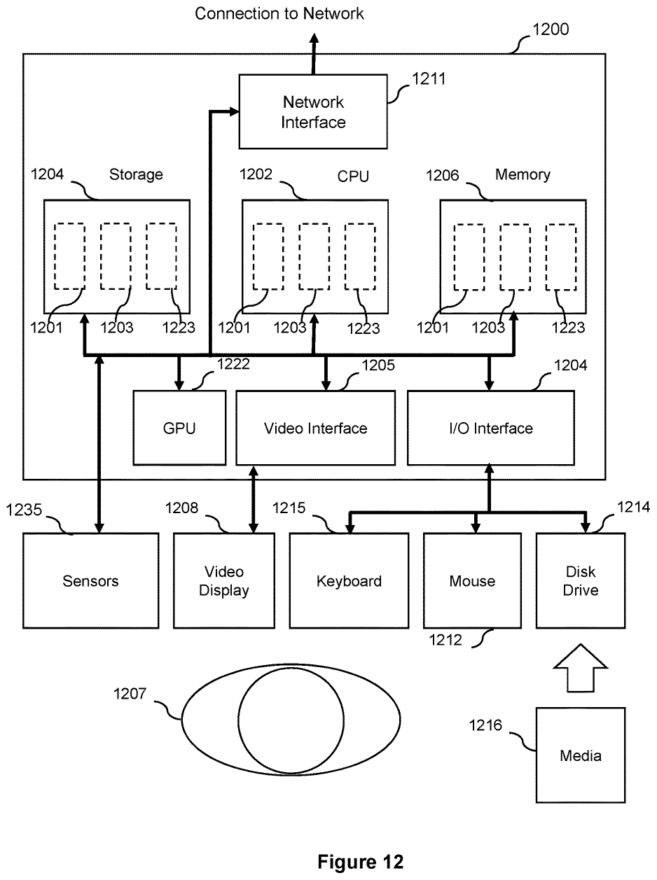

By way of example, FIG. 12 shows a schematic depiction of a computer device 1200 used in the implementation of a communications system of the present disclosure that may include a central processing unit (“CPU”) 1202 connected to a storage unit 1214 and to a random access memory 1206. The CPU 1202 may process an operating system 1201, application program 1203, and data 1223. The operating system 1201, application program 1203, and data 1223 may be stored in storage unit 1214 and loaded into memory 1206, as may be required. Computer device 1200 may further include a graphics processing unit (GPU) 1222 which is operatively connected to CPU 1202 and to memory 1206 to offload intensive image processing calculations from CPU 1202 and run these calculations in parallel with CPU 1202.

An operator 1207 may interact with the computer device 1200 using a video display 1208 connected by a video interface 1205, and various input/output devices such as a keyboard 1215, mouse 1212, and disk drive or solid state drive 1214 connected by an I/O interface 1204. In a known manner, the mouse 1212 may be configured to control movement of a cursor in the video display 1208, and to operate various graphical user interface (GUI) controls appearing in the video display 1208 with a mouse button. The disk drive or solid state drive 1214 may be configured to accept computer readable media 1216. The computer device 1200 may form part of a network via a network interface 1211, allowing the computer device 1200 to communicate with other suitably configured data processing systems (not shown). One or more different types of sensors 1235 may be used to receive input from various sources.

It should be understood that the control of the storage system may be performed by an appropriately configured industrial computing device, however the functionality of the computing device may be implemented using virtually any manner of computer device including a desktop computer, laptop computer, tablet computer, wireless handheld or a cloud computing platform. The computing device or devices may execute one or more software instances, for example virtual machines and or containers. The present system and method may also be implemented as a computer-readable/useable medium that includes computer program code to enable one or more computer devices to implement each of the various process steps in a method in accordance with the present disclosure. In case of more than one computer devices performing the entire operation, the computer devices are networked to distribute the various steps of the operation.

It should be understood that the terms computer-readable medium or computer useable medium comprises one or more of any type of physical embodiment of the program code. In particular, the computer-readable/useable medium can comprise program code embodied on one or more portable storage articles of manufacture (e.g. an optical disc, a magnetic disk, a tape, etc.), on one or more data storage portioned of a computing device, such as memory associated with a computer and/or a storage system. In further aspects, the disclosure provides systems, devices, methods, and computer programming products, including non-transient machine-readable instruction sets, for use in implementing such methods and enabling the functionality described previously.

In an alternative arrangement, the storage and retrieval system may be of a size such that a single base station is sufficient to provide radio coverage to the entirety of the grid surface. In such a case, the BSC may be retained as a separate entity or the functionality of the BSC may be incorporated into to the base station.

It is envisaged that any one or more of the variations described in the foregoing paragraphs may be implemented in the same embodiment of a communications system.

In this document, the language “movement in the n-direction” (and related wording), where n is one of x, y and z, is intended to mean movement substantially along or parallel to the n-axis, in either direction (i.e. towards the positive end of the n-axis or towards the negative end of the n-axis). In this document, the word “connect” and its derivatives are intended to include the possibilities of direct and indirection connection. For example, “x is connected to y” is intended to include the possibility that x is directly connected to y, with no intervening components, and the possibility that x is indirectly connected to y, with one or more intervening components. Where a direct connection is intended, the words “directly connected”, “direct connection” or similar will be used. Similarly, the word “support” and its derivatives are intended to include the possibilities of direct and indirect contact. For example, “x supports y” is intended to include the possibility that x directly supports and directly contacts y, with no intervening components, and the possibility that x indirectly supports y, with one or more intervening components contacting x and/or y. The word “mount” and its derivatives are intended to include the possibility of direct and indirect mounting. For example, “x is mounted on y” is intended to include the possibility that x is directly mounted on y, with no intervening components, and the possibility that x is indirectly mounted on y, with one or more intervening components.

In this document, the word “comprise” and its derivatives are intended to have an inclusive rather than an exclusive meaning. For example, “x comprises y” is intended to include the possibilities that x includes one and only one y, multiple y's, or one or more y's and one or more other elements. Where an exclusive meaning is intended, the language “x is composed of y” will be used, meaning that x includes only y and nothing else. In this document, “controller” is intended to include any hardware which is suitable for controlling (e.g. providing instructions to) one or more other components. For example, a processor equipped with one or more memories and appropriate software to process data relating to a component or components and send appropriate instructions to the component(s) to enable the component(s) to perform its/their intended function(s).

In one regard, the present disclosure provides a system of managing cryptographic keys for use by bots in an automated storage and retrieval system. The allocation of a set of cryptographic keys to each of the bots enables various bot functions to only occur when an appropriate cryptographic key is presented.

1. A method of operating a load handling device in a storage system, the method comprising the steps of:
generating a set of cryptographic keys which are associated with the load handling device;
storing a first cryptographic key of the set of cryptographic keys in the load handling device; and
using a second cryptographic key of the set of cryptographic keys to authenticate the first cryptographic key stored in the load handling device such that software can only be installed onto the load handling device if the authentication is successful.

2. A method according to claim 1 wherein the first cryptographic key is permanently stored in the load handling device.

3. A method according to claim 2 in which the first cryptographic key is permanently burned into a non-volatile data storage unit and the non-volatile data storage unit is subsequently installed into the load handling device.

4. A method according to claim 1, wherein the method comprises the further step of using a third cryptographic key of the set of cryptographic keys to authenticate the first cryptographic key stored in the load handling device such that the load handling device is only inducted into a storage system if the authentication is successful.

5. A method according to claim 4, wherein the inducting of the load handling device into the storage system comprises forming a connection between the load handling device and the storage system via a wireless communication system.

6. A method according to claim 5, wherein the method comprises the further step of using a fourth cryptographic key of the set of cryptographic keys to authenticate the first cryptographic key stored in the load handling device such that the load handling device can only connect to the storage system via the wireless communication system if the authentication is successful.

7. A method according to claim 1, wherein the method comprises the further step of the load handling device generating one or more local cryptographic keys for use in the load handling device.

8. A method according to claim 7, wherein the one or more local cryptographic keys are generated based on the first cryptographic key stored in the load handling device.

9. A load handling device for use in a storage system, the load handling device comprising non-volatile data storage, volatile data storage, one or more processors and a first communications interface for communicating with a wireless communications network of the storage system wherein, in use,
a first cryptographic key from a set of cryptographic keys associated with the load handling device is stored in the non-volatile data storage of the load handling device; and
software that can only be installed onto the load handling device if a second cryptographic key from the set of cryptographic keys successfully authenticates the first cryptographic key.

10. A load handling device according to claim 9, wherein the first cryptographic key is permanently stored in the non-volatile data storage of the load handling device.

11. A load handling device according to claim 9, wherein the non-volatile data storage of the load handling device comprises a one-time programmable memory device.

12. A load handling device according to claim 9, wherein the load handling device further comprises a cryptoprocessor.

13. A load handling device according to claim 12, in which the cryptoprocessor is configured to, in use, generate one or more further cryptographic keys.

14. A load handling device according to claim 13, in which the cryptoprocessor is configured to, in use, generate one or more further cryptographic keys based on the first cryptographic key stored in the non-volatile data storage of the load handling device.

15. A load handling device according to claim 9, wherein, in use, the load handling device is only inducted into a storage system if a third cryptographic key from the set of cryptographic keys successfully authenticates the first cryptographic key.

16. A load handling device according to claim 15, wherein inducting the load handling device into the storage system comprises forming a connection between the load handling device and the storage system via a wireless communication system.

17. A load handling device according to claim 15, wherein in use, the load handling device is only connected to the storage system via the first communications interface if a fourth cryptographic key from the set of cryptographic keys successfully authenticates the first cryptographic key.

18. A load handling device according to claim 9, the load handling device being configured to lift and move containers stacked in stacks in a storage structure, the storage structure including, above the stacks of containers, a first set of tracks extending in a first direction and a second set of tracks extending in a second direction which is transverse to the first direction, the load handling device being configured to move on the tracks above the stacks, the load handling device further comprising:
a body configured to house one or more operation components;
a container-receiving space configured to accommodate at least part of a container;
a first set of wheels configured to engage with the first set of tracks to guide movement of the load handling device in the first direction and a second set of wheels configured to engage with the second set of tracks to guide movement of the load handling device in the second direction;
a wheel-positioning mechanism configured to selectively engage either the first set of wheels with the first set of tracks or the second set of wheels with the second set of tracks, the wheel-positioning mechanism being configured to raise and lower the first set of wheels or the second set of wheels relative to the body, thereby enabling the load handling device to selectively move in either the first direction or the second direction across the tracks of the storage structure; and
container-lifting means comprising a container-engaging assembly configured to releasably engage a container and a raising and lowering assembly configured to raise and lower the container-engaging assembly.

19. A storage system comprising:
a first set of parallel tracks extending in an X-direction, and a second set of parallel tracks extending in a Y-direction transverse to the first set in a substantially horizontal plane to form a grid pattern comprising a plurality of grid spaces;
a plurality of stacks of storage containers located beneath the tracks, and arranged such that each stack is located within a footprint of a single grid space;
at least one load handling device according to claim 9, the at least one load handling device being arranged to selectively move in the X or Y directions, above the stacks on the tracks and arranged to transport a storage container; and
a picking station arranged to receive a storage container transported by the at least one load handling device and to transfer an item from the storage container into a delivery container.

20. The storage system according to claim 18, wherein the at least one load handling device has a footprint that occupies only a single grid space in the storage system, such that a load handling device occupying one grid space does not obstruct a different load handling device occupying or traversing adjacent grid spaces in the X-direction or the Y-direction.

21. (canceled)
